(19) United States
(12) Patent Application Publication
(10) Pub. No.: US 2023/0397094 A1
(43) Pub. Date: Dec. 7, 2023

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Jiangsheng FAN, Dongguan (CN)

(21) Appl. No.: 18/452,224

(22) Filed: Aug. 18, 2023

Related U.S. Application Data
(63) Continuation of application No. PCT/CN2021/077920, filed on Feb. 25, 2021.

(51) Int. Cl. H04W 48/16; H04W 48/04

(52) U.S. Cl. CPC H04W 48/16; H04W 48/04

(57) ABSTRACT

A wireless communication method, a terminal device, and a network device are provided. The method includes the following. Obtain access-control configuration information. Perform cell access control according to the access-control configuration information, where the access-control configuration information indicates information related to a terminal barred from accessing a target network or allowed to access the target network.

### CROSS-REFERENCE TO RELATED APPLICATION(S)

This application is a continuation of PCT Application No. PCT/CN2021/077920, filed Feb. 25, 2021, the entire disclosure of which is incorporated herein by reference.

### TECHNICAL FIELD

Implementations of this disclosure relate to the field of communication, and more particularly to a wireless communication method, a terminal device, and a network device.

### BACKGROUND

Resources of an access network are limited. In order to reduce congestion caused by random access of a terminal to a cell, a unified access control (UAC) mechanism is introduced in a new radio (NR) system, so as to control conditional access of the terminal to the cell. Specifically, 64 access categories (ACs) associated with a service type of the terminal are defined in NR, and each AC corresponds to one set of access control parameters, so that a network side can control access of the terminal to the cell according to the service type.

In a non-terrestrial network (NTN) system, a coverage area of a satellite cell is much larger than that of a terrestrial cell. In general, increase in coverage range of a cell means proportional increase in the number (that is, quantity) of served terminals, but available bandwidth resources of the satellite cell do not increase proportionally with increase in coverage size of the cell. Although a probability of system resource congestion can be reduced by means of the existing service type-based UAC mechanism, the number of potential terminals served by the satellite cell is in huge increase, and therefore, even if the service type-based UAC mechanism is adopted, only some terminals using a corresponding service can be barred and a large number of other service terminals will still congest system resources, which will result in low resource utilization.

### SUMMARY

In a first aspect, a wireless communication method is provided. The method includes the following. Obtain access-control configuration information. Perform cell access control according to the access-control configuration information, where the access-control configuration information indicates information related to a terminal barred from accessing a target network or allowed to access the target network.

In a second aspect, a wireless communication method is provided. The method includes the following. Sending access-control configuration information, where the access-control configuration information indicates information related to a terminal barred from accessing a target network or allowed to access the target network.

In a third aspect, a terminal device is provided. The terminal device includes a transceiver, a processor, and a memory. The memory is configured to store computer programs. The processor is configured to invoke and execute the computer programs stored in the memory, to perform the method described in the first aspect or in various implementations of the first aspect.

In a fourth aspect, a network device is provided. The network device includes a transceiver, a processor, and a memory. The memory is configured to store computer programs. The processor is configured to invoke and execute the computer programs stored in the memory, to perform the method described in the second aspect or in various implementations of the second aspect.

### BRIEF DESCRIPTION OF THE DRAWINGS

FIG. 1A is a schematic architectural diagram of a communication system provided in implementations of the disclosure.

FIG. 1B is a schematic architectural diagram of another communication system provided in implementations of the disclosure.

FIG. 2 is an interaction flowchart of a wireless communication method provided in implementations of the disclosure.

FIG. 3 is a schematic block diagram of a terminal device 300 according to implementations of the disclosure.

FIG. 4 is a schematic block diagram of a network device 400 according to implementations of the disclosure.

FIG. 5 is a schematic structural diagram of a communication device 500 provided in implementations of the disclosure.

FIG. 6 is a schematic structural diagram of an apparatus according to implementations of the disclosure.

FIG. 7 is a schematic block diagram of a communication system 700 provided in implementations of the disclosure.

### DETAILED DESCRIPTION

The following will describe technical solutions of implementations of the disclosure with reference to the accompanying drawings of the implementations of the disclosure. Apparently, implementations described herein are merely some implementations, rather than all implementations, of the disclosure. Based on the implementations described herein, all other implementations obtained by those of ordinary skill in the art without creative effort shall fall within the protection scope of the disclosure.

Technical solutions of implementations of the disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 5^{th} generation (5G) system, or other communication systems.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, or vehicle to everything (V2X) communication, etc. Implementations of the disclosure can also be applied to these communication systems.

Optionally, the communication system in implementations of the disclosure may be applied to a carrier aggregation (CA) scenario, a dual connectivity (DC) scenario, or a standalone (SA) network deployment scenario.

Optionally, implementations of the disclosure may be applied to an unlicensed spectrum, or may be applied to a licensed spectrum. An unlicensed spectrum may be regarded as a shared spectrum, and a licensed spectrum may be regarded as a non-shared spectrum.

Various implementations of the disclosure are described in connection with a network device and a terminal device. The terminal device can be a mobile phone, a pad, a computer with wireless transceiver functions, a virtual reality (VR) terminal device, an augmented reality (AR) terminal device, a wireless terminal in industrial control, an in-vehicle terminal device, a wireless terminal in self driving, a wireless terminal device in remote medicine, a wireless terminal device in smart grid, a wireless terminal device in transportation safety, a wireless terminal device in smart city, a wireless terminal device in smart home, a wearable terminal device, etc. The terminal device may also be referred to as a terminal, a user equipment (UE), an access terminal device, an in-vehicle terminal, a terminal in industrial control, a UE unit, a UE station, a mobile station, a remote station, a remote terminal device, a mobile device, a UE terminal device, a wireless communication device, a UE agent, or a UE apparatus, etc. The terminal device may be stationary or mobile.

By way of explanation rather than limitation, in implementations of the disclosure, the terminal device may also be a wearable device. The wearable device may also be called a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In implementations of the disclosure, the network device may be a device configured to communicate with a mobile device, and the network device may be an access point (AP) in a WLAN, a base transceiver station (BTS) in GSM or CDMA, may also be a NodeB (NB) in WCDMA, and may also be an evolutional Node B (eNB or eNodeB) in LTE, or a relay station or AP, or an in-vehicle device, a wearable device, a network device (gNB) in an NR network, a network device in a future evolved public land mobile network (PLMN), etc.

The network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In implementations of the disclosure, the network device provides services for a cell, and the terminal device communicates with the network device on a transmission resource (for example, a frequency-domain resource or a spectrum resource) for the cell. The cell may be a cell corresponding to the network device (for example, a base station). The cell may correspond to a macro base station, or may correspond to a base station corresponding to a small cell. The small cell may include: a metro cell, a micro cell, a pico cell, a femto cell, and the like. These small cells are characterized by small coverage and low transmission power and are adapted to provide data transmission service with high-rate.

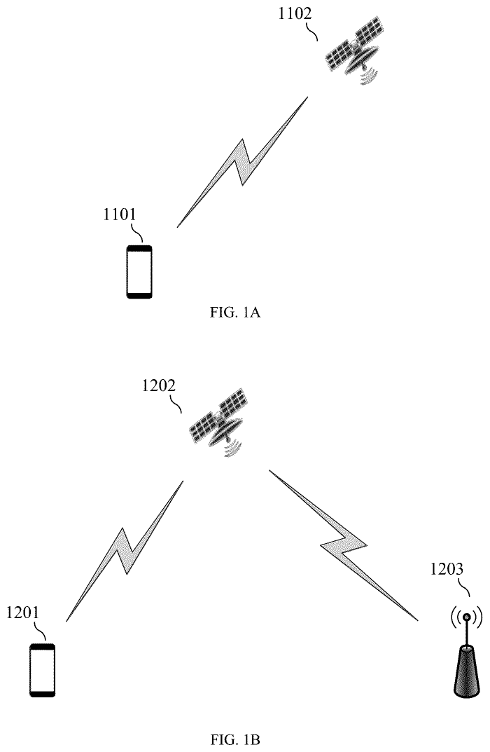

Exemplarily, the following describes an architecture of a communication system in the disclosure with reference to FIGS. 1A and 1B.

FIG. 1A is a schematic architectural diagram of a communication system provided in implementations of the disclosure. Referring to FIG. 1A, a terminal device 1101 and a satellite 1102 are included. The terminal device 1101 and the satellite 1102 can communicate wirelessly with each other. A network formed between the terminal device 1101 and the satellite 1102 may also be referred to as an NTN. In the architecture of the communication system illustrated in FIG. 1A, the satellite 1102 can function as a base station, and the terminal device 1101 and the satellite 1102 can communicate directly with each other, where the satellite 1102 is referred to as a regenerative satellite. In the system architecture, the satellite 1102 may be referred to as a network device. Optionally, there may be multiple network devices 1102 in the communication system, and there may be other quantities of terminal devices in the coverage of each network device 1102, and implementations of the disclosure are not limited in this regard.

FIG. 1B is a schematic architectural diagram of another communication system provided in implementations of the disclosure. Referring to FIG. 1B, a terminal device 1201, a satellite 1202, and a base station 1203 are included. The terminal device 1201 and the satellite 1202 can communicate wirelessly with each other, and the satellite 1202 and the base station 1203 can communicate with each other. A network formed between the terminal device 1201, the satellite 1202, and the base station 1203 may also be referred to as an NTN. In the architecture of the communication system illustrated in FIG. 1B, the satellite 1202 may not function as a base station, and communication between the terminal device 1201 and the base station 1203 needs to be relayed via the satellite 1202, where the satellite 1202 is referred to as a relay satellite. In such a system architecture, the base station 1203 may be referred to as a network device. Optionally, there may be multiple network devices 1203 in the communication system, and there may be other quantities of terminal devices in the coverage of each network device 1203, and implementations of the disclosure are not limited in this regard.

Optionally, the wireless communication system illustrated in FIGS. 1A and 1B may further include other network entities such as a mobility management entity (MME), an access and mobility management function (AMF), etc., and implementations of the disclosure are not limited in this regard.

It should be understood that, the terms “system” and “network” herein are usually used interchangeably throughout this disclosure. The term “and/or” herein only describes an association relationship between associated objects, for example, there can be three relationships between associated objects. For example, A and/or B can mean A alone, both A and B exist, and B alone. The character “/” herein generally indicates that the associated objects are in an “or” relationship.

In the elaboration of implementations of the disclosure, the term “correspondence” may mean that there is a direct or indirect correspondence between the two, may mean that there is an association between the two, or may mean a relationship of indicating and indicated or configuring and configured, etc.

To clearly illustrate the concept of implementations of the disclosure, a brief introduction will be given firstly to the related art of the implementations of the disclosure. The implementations of the disclosure include at least some of the following.

I. Non-Public Network (NPN), Stand-Alone Non-Public Network (SNPN), and Closed Access Group (CAG) Network

The NPN is introduced in NR release 16 (R16). In order to improve flexibility in NPN deployment, the NPN can be classified into an SNPN and a CAG network, where the SNPN is determined according to a PLMN identity (ID) and a network identity (NID), and the CAG network is determined according to a PLMN ID and a CAG identifier (CAG ID). Taking the SNPN as an example, a PLMN ID and an NID may be used as an SNPN identifier, and a subscriber subscribing to a certain SNPN service may be configured with a corresponding subscriber permanent identifier (SUPI) and subscription information, where the corresponding SUPI and the subscription information are stored in a terminal device and a core-network side. A subscriber subscribing to an SNPN service is required to support an SNPN access mode. A subscriber set to operate in the SNPN access mode can access a network only through the SNPN, and a subscriber not set to operate in the SNPN access mode can perform a PLMN selection procedure. The configuration (activation, deactivation, etc.) of the SNPN access mode is up to implementation of the terminal device. In an initial access and cell re-selection procedure, an access-network device needs to broadcast an NID supported by the access-network device and a corresponding PLMN ID, and the subscriber set to operate in the SNPN access mode can select an accessible SNPN cell according to subscription information of the subscriber. A core-network device can also authenticate an identity of the subscriber according to the subscription information of the subscriber.

A PLMN can be shared by any combination of a common public network, an SNPN, and a CAG network. For example, a PLMN may be shared by a common public network, an SNPN, or a CAG network; or may be shared by a combination of a common public network and an SNPN; or may even be shared by a combination of a common public network, an SNPN, and a CAG network. In other words, a common public network(s), an SNPN(s), or a CAG network(s) may share a PLMN, or a common public network and an SNPN may share a PLMN, or even a common public network, an SNPN, and a CAG network may share a PLMN. The following will describe more clearly a logical deployment relationship among a common public network, an SNPN, and a CAG network in connection with table 1.

TABLE 1
Schematic NID configurations that a cell may support

| NID | PLMN ID list | PLMN ID 1 | |
|---|---|---|---|
| broadcast | | PLMN ID 2 | |
| by a cell | | . . . | |
| | | PLMN ID N | |
| | NPN ID list | PLMN ID N + 1 | CAG ID list 1 |
| | (optional) | PLMN ID N + 2 | CAG ID list 2 |
| | | . . . | . . . |
| | | PLMN ID N + M | CAG ID list M |
| | | PLMN ID N + M + 1 | NID list 1 |
| | | PLMN ID N + M + 2 | NID list 2 |
| | | . . . | . . . |
| | | PLMN ID N + M + W | NID list W |

As shown in table 1, from the perspective of network configuration, a cell can be configured with both a PLMN ID list and an NPN ID list, where the NPN ID list is an optional parameter introduced in NR R16. For a CAG-type NPN, one PLMN ID is allowed to be associated with one CAG ID list. For an SNPN-type NPN, one PLMN ID is allowed to be associated with one NID list.

Parameters N, M, and Win table 1 each are a positive integer greater than or equal to 1.

II. Unified Access Control (UAC) Mechanism

As stated above, resources of an access network are limited. In order to reduce congestion caused by random access of a terminal to a cell, a UAC mechanism is introduced in an NR system, so as to control conditional access of the terminal to the cell. Specifically, 64 access categories (ACs) associated with a service type of the terminal are defined in NR, and each AC corresponds to one set of access control parameters, so that a network side can control access of the terminal to the cell according to the service type.

A UAC parameter may be configured at cell granularity (namely, all PLMNs shared by a cell share the UAC parameter) or configured at PLMN granularity. For details thereof, reference can be made to table 2 and table 3.

TABLE 2
Schematic UAC parameters configured at cell granularity

| Information of | | AC-granularity access |
|---|---|---|
| shared PLMNs of a cell | AC information | control parameter |
| PLMN 1~PLMN N | AC 0 | Access control parameter 1 |
| | AC 1 | Access control parameter 2 |
| | . . . | . . . |
| | AC 63 | Access control parameter 64 |

As shown in table 2, all PLMNs shared by a cell share a set of common UAC parameters, where the UAC parameter includes AC information and an access control parameter associated with the corresponding AC. Generally, the access control parameter includes parameters such as an access control probability, an access barring duration, and an access identity for the terminal, etc.

TABLE 3
Schematic UAC parameter configured at PLMN granularity

| Information of PLMNs | | AC-granularity access |
|---|---|---|
| shared by a cell | AC information | control parameter |
| PLMN 1 | AC 0 | Access control parameter 1 |
| | AC 1 | Access control parameter 2 |
| | . . . | . . . |
| | AC 63 | Access control parameter 64 |
| PLMN 2 | AC 0 | Access control parameter 1 |
| | AC 1 | Access control parameter 2 |
| | . . . | . . . |
| | AC 63 | Access control parameter 64 |

In table 3, a cell exemplarily has two shared PLMNs. Each PLMN is configured with a separate set of UAC parameters. The UAC parameter includes AC information and an access control parameter associated with the corresponding AC. Generally, the access control parameter includes parameters such as an access control probability, an access barring duration, and an access identity for the terminal, etc.

As described above, in an NTN system, a coverage area of a satellite cell is much larger than that of a terrestrial cell. In general, increase in coverage range of a cell means proportional increase in the number (that is, quantity) of served terminals, but available bandwidth resources of the satellite cell do not increase proportionally with increase in coverage size of the cell. Although a probability of system resource congestion can be reduced by means of the existing service type-based UAC mechanism, the number of potential terminals served by the satellite cell is in huge increase, and therefore, even if the service type-based UAC mechanism is adopted, only some terminals using a corresponding service can be barred and a large number of other service terminals will still congest system resources, which will result in low resource utilization.

Implementations of the disclosure provide a wireless communication method, a terminal device, and a network device, which can realize efficient utilization of network resources.

Technical solutions of the disclosure will be described in detail below.

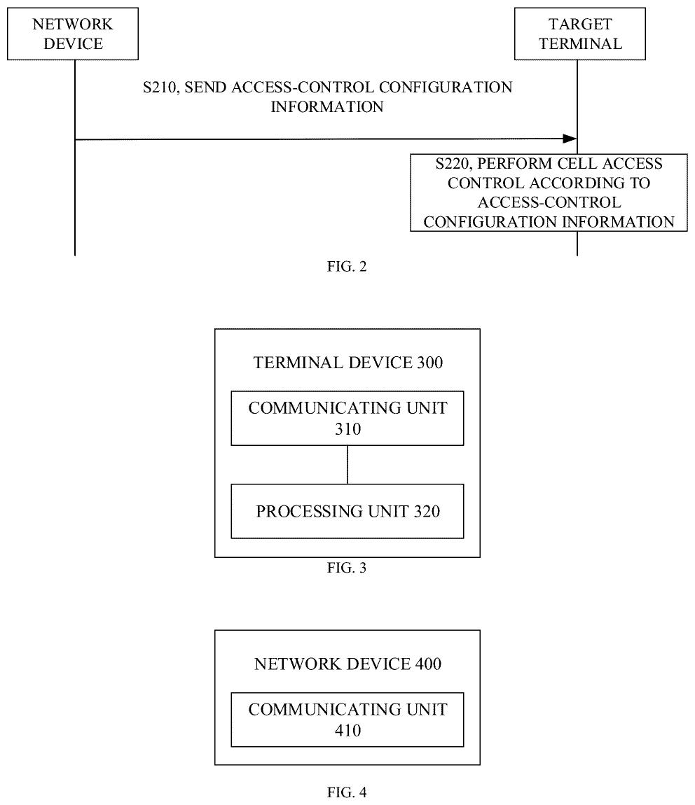

FIG. 2 is an interaction flowchart of a wireless communication method provided in implementations of the disclosure. An execution entity involved in the method includes a target terminal and a network device. As illustrated in FIG. 2, the method includes the following.
S210, the network device sends access-control configuration information.
S220, the target terminal performs cell access control according to the access-control configuration information.

The access-control configuration information indicates information related to a terminal barred from accessing a target network or allowed to access the target network. It should be understood that, the terminal herein may be one terminal or multiple terminals, and the terminal does not specifically refer to the target terminal above.

Optionally, if the access-control configuration information indicates information related to a terminal barred from accessing the target network, assuming that the target terminal determines, according to the access-control configuration information, that the target terminal is barred from accessing the target network, the target terminal may further determine, according to a corresponding intra-frequency cell search indicator bit in a master information block (MIB) of the target network, whether the target terminal can search for other cells at the same frequency as the target network. Alternatively, the target terminal may directly ignore the corresponding intra-frequency cell search indicator bit in the MIB of the target network, and consider that the target terminal can search for other cells at the same frequency as the target network, or consider that the target terminal cannot search for other cells at the same frequency as the target network in a time period.

It should be understood that, there are two cases regarding the access-control configuration information being indicative of information related to a terminal allowed to access the target network. In one case, the access-control configuration information is indicative of information related to a terminal always allowed to access the target network, in other words, as long as the target terminal determines, according to the access-control configuration information, that the target terminal is allowed to access the target network, the target terminal can access the target network. In the other case, the access-control configuration information is indicative of information related to a terminal conditionally allowed to access the target network, that is, even if the target terminal determines, according to the access-control configuration information, that the target terminal is allowed to access the target network, the target terminal further needs to take other factors into consideration to determine whether the target terminal can access the target network, for example, the target terminal determines, according to a probability configuration parameter for the target terminal to access the target network, whether the target terminal can access the target network.

Optionally, the target network may be a registered network of the target terminal, that is, an operator network that the target terminal subscribes to, or may be a network equivalent to the registered network, and the disclosure is not limited in this regard.

Optionally, the access-control configuration information includes an ID of the target network.

Optionally, the target network is any one of, but is not limited to, a PLMN network, an SNP network, or a CAG network.

Optionally, the access-control configuration information is carried in a system broadcast message or dedicated signaling.

Optionally, the dedicated signaling may be radio resource control (RRC) setup signaling, RRC re-establishment signaling, etc., and the disclosure is not limited in this regard.

It should be understood that, if the target terminal determines, according to the access-control configuration information, that the target terminal is barred from accessing the target network, the target terminal will not access the target network. If the target terminal determines, according to the access-control configuration information, that the target terminal is allowed to access the target network, the target terminal will access the target network, or the target terminal will determine, further according to the probability configuration parameter for the target terminal to access the target network, whether the target terminal can access the target network.

Optionally, the target terminal may obtain the access-control configuration information via an access stratum (AS), and may transfer the access-control configuration information to a non-access stratum (NAS) via the AS.

In the disclosure, the target terminal can obtain the access-control configuration information, and perform cell access control according to the access-control configuration information, thereby realizing an access control mechanism. Compared with a service type-based UAC mechanism, in this access control mechanism, it is possible to explicitly indicate, according to an actual network condition, a terminal barred from accessing the target network or allowed to access the target network. For example, the network device may indicate a terminal of terminal type A to access the target network, or may indicate to bar terminals of terminal types other than terminal type A from accessing the target network, which can reduce resource congestion caused by a large quantity of terminals accessing a network, thereby realizing efficient utilization of network resources.

Optionally, the access-control configuration information includes at least one of, but is not limited to, information of a type of a terminal (“terminal type” for short) barred from accessing the target network or allowed to access the target network, geographic region information of the terminal barred from accessing the target network or allowed to access the target network, or information related to a serving cell of the terminal barred from accessing the target network or allowed to access the target network.

It should be understood that, in the disclosure, there are two cases regarding information of a terminal type allowed to access the target network. In one case, the information of the terminal type allowed to access the target network refers to information of a terminal type always allowed to access the target network, that is, as long as the target terminal is the terminal type allowed to access the target network, the target terminal can access the target network. In the other case, the information of the terminal type allowed to access the target network refers to information of a terminal type conditionally allowed to access the target network, that is, even if the target terminal is the terminal type allowed to access the target network, the target terminal further needs to take other factors into consideration to determine whether the target terminal can access the target network. For example, the target terminal determines, according to the probability configuration parameter for the target terminal to access the target network, whether the target terminal can access the target network.

Similarly, there are two cases regarding geographic region information of a terminal allowed to access the target network. In one case, the geographic region information of the terminal allowed to access the target network refers to geographic region information of a terminal always allowed to access the target network, that is, as long as the target terminal is within a geographic region of the terminal allowed to access the target network, the target terminal can access the target network. In the other case, the geographic region information of the terminal allowed to access the target network refers to geographic region information of a terminal conditionally allowed to access the target network, that is, even if the target terminal is within the geographic region of the terminal allowed to access the target network, the target terminal further needs to take other factors into consideration to determine whether the target terminal can access the target network. For example, the target terminal determines, according to the probability configuration parameter for the target terminal to access the target network, whether the target terminal can access the target network.

Similarly, there are two cases regarding information related to a serving cell of a terminal allowed to access the target network. In one case, the information related to the serving cell of the terminal allowed to access the target network refers to information related to a serving cell of a terminal always allowed to access the target network, that is, as long as information related to a serving cell of the target terminal is consistent with the information related to the serving cell of the terminal allowed to access the target network, the target terminal can access the target network. In the other case, the information related to the serving cell of the terminal allowed to access the target network refers to information related to a serving cell of a terminal conditionally allowed to access the target network, that is, even if the information related to the serving cell of the target terminal is consistent with the information related to the serving cell of the terminal allowed to access the target network, the target terminal further needs to take other factors into consideration to determine whether the target terminal can access the target network. For example, the target terminal determines, according to the probability configuration parameter for the target terminal to access the target network, whether the target terminal can access the target network.

Optionally, the terminal type is classified according to at least one of, but not limited to, the following dimensions: 1. a maximum transmission power level supported by the terminal; 2. an application scenario supported by the terminal; 3. a bandwidth size supported by the terminal; 4. whether the terminal is served (i.e., is provided with service) in an operator network that the terminal subscribes to; 5. the number (that is, quantity) of transmit antennas and/or the number of receive antennas supported by the terminal.

Optionally, the above classifications of the terminal type may be predefined in a standard, and the disclosure is not limited in this regard.

Optionally, a maximum transmission power level may be classified into different maximum transmission power ranges according to the maximum transmission power level supported by the terminal, and each range corresponds to one terminal type. Exemplarily, a terminal with a maximum transmission power less than a is classified into one type, a terminal with a maximum transmission power greater than or equal to a and less than or equal to b is classified into another type, and a terminal with a maximum transmission power greater than or equal to b is classified into still another type.

It should be noted that, in the disclosure, there is no limitation on the quantity of maximum transmission power ranges for the maximum transmission power level and how to classify the maximum transmission power level into maximum transmission power ranges.

Optionally, in the disclosure, application scenarios of the terminal may be classified at different dimensions. For example, the application scenario of the terminal may be classified into three types according to whether the terminal supports only terrestrial communication, supports only satellite communication, or supports both terrestrial communication and satellite communication. Alternatively, the application scenario of the terminal may be classified into three types according to whether the terminal supports only a stationary scenario, supports only a mobile scenario, or supports both a static scenario and a mobile scenario. As such, the terminal can be classified into different types according to different application scenarios. Exemplarily, a terminal that supports only terrestrial communication is classified into one type, a terminal that supports only satellite communication is classified into another type, and a terminal that supports both terrestrial communication and satellite communication is classified into still another type. Alternatively, a terminal that supports only a stationary scenario is classified into one type, a terminal that supports only a mobile scenario is classified into another type, and a terminal that supports both a stationary scenario and a mobile scenario is classified into still another type.

Optionally, bandwidths may be classified into different bandwidth ranges according to the bandwidth supported by the terminal, where each range corresponds to one terminal type. Exemplarily, a terminal having a bandwidth less than c is classified into one type, a terminal having a bandwidth greater than or equal to c and less than or equal to d is classified into another type, and a terminal having a bandwidth greater than or equal to d is classified into still another type.

It should be understood that, classification of the terminal type according to whether the terminal is served in the operator network that the terminal subscribes to is also referred to as classification according to a relationship between an operator network actually found by the terminal and the operator that the terminal subscribes to. In other words, there are two terminal types. One terminal type refers to a terminal served in the operator network that the terminal subscribes to, and this terminal type is referred to as terminal type 1. The other terminal type refers to a terminal not served in the operator network that the terminal subscribes to, and this terminal type is referred to as terminal type 2.

Exemplarily, assuming that terminal A subscribes to PLMN 1 and terminal A is served in PLMN 1, terminal A is terminal type 1. If terminal B subscribes to PLMN 2 and terminal B is not served in PLMN 2, terminal B is terminal type 2.

The following will give an exemplary illustration of determining the terminal type according to the number of transmit antennas supported by the terminal. For the method for determining the terminal type according to the number of receive antennas supported by the terminal or according to the number of transmit antennas and the number of receive antennas supported by the terminal, reference can be made to the method for determining the terminal type according to the number of transmit antennas supported by the terminal, which will not be describe in detail in the disclosure.

Exemplarily, a terminal of which the number of transmit antennas is less than e is classified into one type, a terminal of which the number of transmit antennas is greater than or equal to e and less than or equal to f is classified into another type, and a terminal of which the number of transmit antennas is greater than or equal to f is classified into still another type.

It should be noted that, items 1−5 for determining the terminal type may be randomly combined, for example, a terminal of which the maximum transmission power level is P1 and the bandwidth supported is B1 is defined as one terminal type, and a terminal of which the maximum transmission power level is P2 and the bandwidth supported is B2 is defined as another terminal type. Other combinations will not be elaborated in the disclosure.

Optionally, the geographic region information includes coordinate information of multiple reference points, or latitude-longitude range information. The multiple reference points may constitute a geographic region. A geographic region may also be constituted according to the latitude-longitude range information.

Exemplarily, assuming that there are four reference points, namely D1, D2, D3, and D4, and the four reference points are connected to constitute a geographic region.

Exemplarily, assuming that four pieces of latitude-longitude range information are configured, namely C1 degrees east longitude, C2 degrees east longitude, C3 degrees north latitude, and C4 degrees south latitude, and the four pieces of latitude-longitude range information constitute a geographic region.

Optionally, the information related to the serving cell of the terminal includes at least one of, but is not limited to, a cell global identity (CGI), a tracking area code (TAC) ID, a radio access network area code (RANAC) ID, frequency-point information, a physical cell identity (PCI), beam information, bandwidth configuration information, radio access technology (RAT) information, or core-network type information.

It should be understood that, the target terminal can be barred from accessing the target network or allowed to access the target network only if the information related to the serving cell of the target terminal is consistent with the information related to the serving cell of the terminal carried in the access-control configuration information. For example, assuming that the information related to the serving cell of the terminal includes CGI 1 and the access-control configuration information indicates information related to the terminal allowed to access the target network, the target terminal can access the target network only if a CGI of the target terminal is CGI 1.

It should be understood that, various configurations included in the information related to the serving cell of the terminal may be at the same level (that is, in parallel relationship), or may be at different levels (that is, in hierarchy relationship). For example, the CGI and the TAC ID are at the same level, and the frequency-point information and the PCI are at different levels, as shown in table 4.

TABLE 4
Schematic configuration relationship between
frequency-point information and PCI

| | |
|---|---|
| Frequency point 1 | PCI 1 |
| | PCI 2 |
| Frequency point 2 | PCI 3 |
| | PCI 4 |

As described above, the information related to the terminal allowed to access the target network indicated by the access-control configuration information may be information related to a terminal conditionally allowed to access the target network. In this case, optionally, if the access-control configuration information indicates the information related to the terminal allowed to access the target network, the access-control configuration information further includes access-probability-control configuration information for the terminal to access the target network.

It should be noted that, none of the terminals in the disclosure specifically refer to a certain terminal such as the target terminal described above.

Optionally, the access-probability-control configuration information includes a probability configuration parameter for the terminal to access the target network. For example, if a probability for the terminal accesses the target network is 0.8, it indicates the terminal accesses the target network with an 80% probability each time.

Optionally, the access-probability-control configuration information further includes a back-off time parameter, where the back-off time parameter is used for determining a minimum waiting duration required before re-initiating a service after the terminal fails to access the target network. The back-off time parameter may also be substituted into a formula to calculate a new minimum waiting duration. For example, if the back-off time parameter is 1 second, the service can be re-initiated only after waiting for 1 second after the service initiated by the terminal is barred, or the service can be re-initiated only after waiting for 0.6*1 second. The service restricted by the back-off time parameter can be a service of the terminal previously barred, or may be a new service, and the disclosure is not limited in this regard.

Optionally, the information of the terminal type and the access-probability-control configuration information are in one-to-one correspondence or multiple-to-one correspondence. For example, table 5 shows a schematic one-to-one mapping between the information of the terminal type and the access-probability-control configuration information, and table 6 shows a schematic multiple-to-one mapping between the information of the terminal type and the access-probability-control configuration information.

TABLE 5
Schematic one-to-one mapping between information of terminal
type and access-probability-control configuration information

| | |
|---|---|
| Terminal type 1 | First set of access-probability-control |
| | configuration information |
| Terminal type 2 | Second set of access-probability-control |
| | configuration information |
| . . . | . . . |
| Terminal type N | N^{th} set of access-probability-control |
| | configuration information |

TABLE 6
Schematic multiple-to-one mapping between information of terminal
type and access-probability-control configuration information

| | |
|---|---|
| Terminal type 1 | First set of access-probability-control |
| | configuration information |
| Terminal type 2 | Second set of access-probability-control |
| Terminal type 3 | configuration information |
| Terminal type 4 | Third set of access-probability-control |
| Terminal type 5 | configuration information |
| Terminal type 6 | |
| Terminal type 7 | |

Optionally, the geographic region information and the access-probability-control configuration information are in one-to-one correspondence or multiple-to-one correspondence. For example, table 7 shows a schematic one-to-one mapping between the geographic region information and the access-probability-control configuration information, and table 8 shows a schematic multiple-to-one mapping between the geographic region information and the access-probability-control configuration information.

TABLE 7
Schematic one-to-one mapping between geographic region information
and access-probability-control configuration information

| | |
|---|---|
| Geographic region 1 | First set of access-probability-control |
| | configuration information |
| Geographic region 2 | Second set of access-probability-control |
| | configuration information |
| . . . | . . . |
| Geographic region N | N^{th} set of access-probability-control |
| | configuration information |

TABLE 8
Schematic multiple-to-one mapping between geographic
region information and access-probability-
control configuration information

| | |
|---|---|
| Geographic region 1 | First set of access-probability-control |
| | configuration information |
| Geographic region 2 | Second set of access-probability-control |
| Geographic region 3 | configuration information |
| Geographic region 4 | Third set of access-probability-control |
| Geographic region 5 | configuration information |
| Geographic region 6 | |
| Geographic region 7 | |

Optionally, the information related to the serving cell of the terminal and the access-probability-control configuration information are in one-to-one correspondence or multiple-to-one correspondence. For example, table 9 shows a schematic one-to-one mapping between the information related to the serving cell of the terminal and the access-probability-control configuration information, and table 10 shows a schematic multiple-to-one mapping between the information related to the serving cell of the terminal and the access-probability-control configuration information.

TABLE 9
Schematic one-to-one mapping between information
related to serving cell of terminal and access-
probability-control configuration information

| | |
|---|---|
| Information 1 related to serving | First set of access-probability-control |
| cell of terminal | configuration information |
| Information 2 related to serving | Second set of access-probability-control |
| cell of terminal | configuration information |
| . . . | . . . |
| Information N related to serving | N^{th} set of access-probability-control |
| cell of terminal | configuration information |

TABLE 10
Schematic multiple-to-one mapping between information
related to serving cell of terminal and access-probability-
control configuration information

| | |
|---|---|
| Information 1 related to serving | First set of access-probability-control |
| cell of terminal | configuration information |
| Information 2 related to serving | Second set of access-probability-control |
| cell of terminal | configuration information |
| Information 3 related to serving | |
| cell of terminal | |
| Information 4 related to serving | Third set of access-probability-control |
| cell of terminal | configuration information |
| Information 5 related to serving | |
| cell of terminal | |
| Information 6 related to serving | |
| cell of terminal | |
| Information 7 related to serving | |
| cell of terminal | |

In the disclosure, the target terminal can obtain the access-control configuration information, and perform various cell access control according to the access-control configuration information. For example, an access control mechanism is realized based on the terminal type, the geographic region information of the terminal, and the information related to the serving cell of the terminal. Compared with a service type-based UAC mechanism, in this access control mechanism, it is possible to explicitly indicate, according to an actual network condition, a terminal barred from accessing the target network or allowed to access the target network. For example, the network device may indicate a terminal of terminal type A to access the target network, or may indicate to bar terminals of terminal types other than terminal type A from accessing the target network, which can reduce resource congestion caused by a large quantity of terminals accessing a network, thereby realizing efficient utilization of network resources.

Optionally, any item in the access-control configuration information is configured at any one of, but not limited to, the following granularities: cell granularity, PLMN granularity, SNPN granularity, CAG granularity, or AC granularity.

As stated above, the access-control configuration information may also include the ID of the target network. For example, the ID of the target network is referred to as first configuration information, the information of the terminal type barred from accessing the target network or allowed to access the target network is referred to as second configuration information, the geographic region information of the terminal barred from accessing the target network or allowed to access the target network is referred to as third configuration information, the information related to the serving cell of the terminal barred from accessing the target network or allowed to access the target network is referred to as fourth configuration information, and the access-probability-control configuration information for the terminal to access the target network is referred to as fifth configuration information. Regarding each information in the access-control configuration information, configurations at the several granularities mentioned above will be illustrated below.

TABLE 11
Schematic configuration at cell granularity

First configuration information
Second configuration information
Third configuration information
Fourth configuration information
Fifth configuration information

As shown in table 11, the second configuration information to the fifth configuration information are all configured in parallel with the first configuration information. Since the first configuration information is configuration information at the cell granularity, the second configuration information to the fifth configuration information each are also configuration information at the cell granularity.

TABLE 12
Schematic configuration at PLMN/SNPN granularity

| | |
|---|---|
| PLMN 1/SNPN 1 | Second configuration information |
| | 1~fifth configuration information 1 |
| PLMN 2/SNPN 2 | Second configuration information |
| | 2~fifth configuration information 2 |
| . . . | . . . |
| PLMN N/SNPN N | Second configuration information |
| | N~fifth configuration information N |

As shown in table 12, the second configuration information to the fifth configuration information are configured at a lower-level relative to PLMN/SNPN information, and accordingly, the second configuration information to the fifth configuration information are configured at the PLMN/SNPN granularity.

TABLE 13
Schematic configuration at CAG granularity

| | | |
|---|---|---|
| PLMN 1 | CAG 11 | Second configuration |
| | | information 11~fifth |
| | | configuration |
| | | information 11 |
| | CAG 12 | Second configuration |
| | | information 12~fifth |
| | | configuration |
| | | information 12 |
| | . . . | . . . |
| | CAG 1N | Second configuration |
| | | information 1N~fifth |
| | | configuration |
| | | information 1N |
| PLMN 2 | CAG 21 | Second configuration |
| | | information 21~fifth |
| | | configuration |
| | | information 21 |
| | CAG22 | Second configuration |
| | | information 22~fifth |
| | | configuration |
| | | information 22 |
| | . . . | . . . |
| | CAG 2M | Second configuration |
| | | information 2M~fifth |
| | | configuration |
| | | information 2M |

As shown in table 13, CAG is configured at a lower-level relative to PLMN while the second configuration information to the fifth configuration information are configured at a lower level relative to CAG, and accordingly, the second configuration information to the fifth configuration information are configured at the CAG granularity.

TABLE 14
Schematic configuration at AC granularity

| | |
|---|---|
| AC 1 | Second configuration information |
| | 1~fifth configuration information 1 |
| AC 2 | Second configuration information |
| | 2~fifth configuration information 2 |
| . . . | . . . |
| AC N | Second configuration information |
| | N~fifth configuration information N |

Optionally, if any item in the access-control configuration information is configured at the AC granularity, the access-control configuration information further includes an AC ID.

Optionally, the AC ID and the access-probability-control configuration information are in one-to-one correspondence or multiple-to-one correspondence.

It should be noted that, if the AC ID and the access-probability-control configuration information are in one-to-one correspondence, there are two configuration modes. In mode 1, the AC ID is explicitly configured, and in this case, each explicit AC ID corresponds to one set of access-probability-control configuration information. In mode 2, the AC ID is absent, and instead, 64 sets of access-probability-control configuration information are configured by default. As to the order of configuration, a first set of access-probability-control configuration information corresponds to AC 0, a second set of access-probability-control configuration information corresponds to AC 1, and so forth, and a 64^{th} set of access-probability-control configuration information corresponds to AC 63. The access-probability-control configuration information in mode 2 is also configured at the AC granularity but implemented implicitly, and the disclosure is not limited in this regard.

For example, table 15 shows a schematic one-to-one mapping between the AC ID and the access-probability-control configuration information, and table 16 shows a schematic multiple-to-one mapping between the AC ID and the access-probability-control configuration information.

TABLE 15
Schematic one-to-one mapping between AC ID and access-
probability-control configuration information

| | |
|---|---|
| AC 1 | First set of access control parameters |
| AC 2 | Second set of access control parameters |
| . . . | . . . |
| AC N | N^{th} set of access control parameters |

TABLE 16
Schematic multiple-to-one mapping between AC ID and
access-probability-control configuration information

| | |
|---|---|
| AC 1 | First set of access control parameters |
| AC 2 | Second set of access control parameters |
| AC 3 | |
| AC 4 | Third set of access control parameters |
| AC 5 | |
| AC 6 | |
| AC 7 | |

In the disclosure, any information in the access-control configuration information is configured at any one of the cell granularity, the PLMN granularity, the SNPN granularity, the CAG granularity, or the AC granularity, which is possible to improve flexibility in configuration of the access-control configuration information.

Optionally, if the access-control configuration information is carried in the dedicated signaling, the access-control configuration information further includes timer information. The access-control configuration information in the dedicated signaling is valid before expiry of the timer; otherwise, the access-control configuration information in the dedicated signaling is invalid.

Optionally, if the access-control configuration information is carried in the dedicated signaling and the access-control configuration information in the dedicated signaling is invalid, that is, the access-control configuration information is carried in the dedicated signaling and the timer expires, the target terminal will perform cell access control according to the access-control configuration information carried in the system broadcast message.

To summarize, in the disclosure, if the access-control configuration information is carried in the dedicated signaling and the access-control configuration information in the dedicated signaling is invalid, the target terminal will perform cell access control according to the access-control configuration information carried in the system broadcast message, thereby improving reliability of cell access control.

With technical solutions of implementations of the disclosure, the target terminal can obtain the access-control configuration information, and perform cell access control according to the access-control configuration information, thereby realizing an access control mechanism. Compared with a service type-based unified access control (UAC) mechanism, in this access control mechanism, it is possible to explicitly indicate, according to an actual network condition, a terminal barred from accessing the target network or allowed to access the target network, which can reduce resource congestion caused by a large quantity of terminals accessing a network, thereby realizing efficient utilization of network resources.

The method implementations of the disclosure are described in detail above with reference to FIG. 2, and apparatus implementations of the disclosure will be described in detail below with reference to FIG. 3 to FIG. 7. It should be understood that, apparatus implementations and method implementations correspond to each other, and for similar illustration, reference can be made to the method implementations.

FIG. 3 is a schematic block diagram of a terminal device 300 according to implementations of the disclosure. As illustrated in FIG. 3, the terminal device 300 includes a communicating unit 310 and a processing unit 320. The communicating unit 310 is configured to obtain access-control configuration information. The processing unit 320 is configured to perform cell access control according to the access-control configuration information, where the access-control configuration information indicates information related to a terminal barred from accessing a target network or allowed to access the target network.

Optionally, the access-control configuration information includes at least one of: information of a terminal type barred from accessing the target network or allowed to access the target network, geographic region information of the terminal barred from accessing the target network or allowed to access the target network, or information related to a serving cell of the terminal barred from accessing the target network or allowed to access the target network.

Optionally, if the access-control configuration information indicates information related to a terminal allowed to access the target network, the access-control configuration information further includes access-probability-control configuration information for the terminal to access the target network.

Optionally, the access-probability-control configuration information includes a probability configuration parameter for the terminal to access the target network.

Optionally, the access-probability-control configuration information further includes a back-off time parameter, where the back-off time parameter is used for determining a minimum waiting duration required before re-initiating a service after the terminal fails to access the target network.

Optionally, the information of the terminal type and the access-probability-control configuration information are in one-to-one correspondence or multiple-to-one correspondence.

Optionally, the geographic region information and the access-probability-control configuration information are in one-to-one correspondence or multiple-to-one correspondence.

Optionally, the information related to the serving cell of the terminal and the access-probability-control configuration information are in one-to-one correspondence or multiple-to-one correspondence.

Optionally, any item in the access-control configuration information is configured at any one of: cell granularity, PLMN granularity, SNPN granularity, CAG granularity, or AC granularity.

Optionally, if any item in the access-control configuration information is configured at the AC granularity, the access-control configuration information further includes an AC ID.

Optionally, the AC ID and the access-probability-control configuration information are in one-to-one correspondence or multiple-to-one correspondence.

Optionally, the terminal type is classified according to at least one of a maximum transmission power level supported by the terminal, an application scenario supported by the terminal, a bandwidth size supported by the terminal, whether the terminal is served in an operator network that the terminal subscribes to, or the number of transmit antennas and/or the number of receive antennas supported by the terminal.

Optionally, the geographic region information includes coordinate information of multiple reference points, or latitude-longitude range information.

Optionally, the information related to the serving cell of the terminal includes at least one of a CGI, a TAC ID, a RANAC ID, frequency-point information, a PCI, beam information, bandwidth configuration information, RAT information, or core-network type information.

Optionally, the access-control configuration information further includes an ID of the target network.

Optionally, the target network is any one of: a PLMN network, an SNPN network, or a CAG network.

Optionally, the access-control configuration information is carried in a system broadcast message or dedicated signaling.

Optionally, if the access-control configuration information is carried in the dedicated signaling, the access-control configuration information further includes timer information. The access-control configuration information in the dedicated signaling is valid before expiry of the timer; otherwise, the access-control configuration information in the dedicated signaling is invalid.

Optionally, the communicating unit 310 is further configured to receive the system broadcast message if the access-control configuration information is carried in the dedicated signaling and the access-control configuration information in the dedicated signaling is invalid. The processing unit 320 is further configured to perform cell access control according to the access-control configuration information carried in the system broadcast message.

Optionally, the communicating unit 310 is specifically configured to obtain the access-control configuration information via an AS. The processing unit 320 is further configured to transfer the access-control configuration information to an NAS via the AS.

Optionally, in some implementations, the communicating unit above may be a communication interface or a transceiver, or may be an input-output interface of a communication chip or system-on-chip (SOC). The processing unit above may be one or more processors.

It should be understood that, the terminal device 300 according to implementations of the disclosure may correspond to the target terminal in the method implementations of the disclosure, and the above and other operations and/or functions of various units of the terminal device 300 are respectively intended for implementing corresponding operations of the target terminal in implementation 1 to implementation 4, which will not be repeated herein for the sake of simplicity.

FIG. 4 is a schematic block diagram of a network device 400 according to implementations of the disclosure. As illustrated in FIG. 4, the network device 400 includes a communicating unit 410. The communicating unit 410 is configured to send access-control configuration information, where the access-control configuration information indicates information related to a terminal barred from accessing a target network or allowed to access the target network.

Optionally, the access-control configuration information includes at least one of: information of a terminal type barred from accessing the target network or allowed to access the target network, geographic region information of the terminal barred from accessing the target network or allowed to access the target network, or information related to a serving cell of the terminal barred from accessing the target network or allowed to access the target network.

Optionally, if the access-control configuration information indicates information related to a terminal allowed to access the target network, the access-control configuration information further includes access-probability-control configuration information for the terminal to access the target network.

Optionally, the access-probability-control configuration information includes a probability configuration parameter for the terminal to access the target network.

Optionally, the access-probability-control configuration information further includes a back-off time parameter, where the back-off time parameter is used for determining a minimum waiting duration required before re-initiating a service after the terminal fails to access the target network.

Optionally, the information of the terminal type and the access-probability-control configuration information are in one-to-one correspondence or multiple-to-one correspondence.

Optionally, the geographic region information and the access-probability-control configuration information are in one-to-one correspondence or multiple-to-one correspondence.

Optionally, the information related to the serving cell of the terminal and the access-probability-control configuration information are in one-to-one correspondence or multiple-to-one correspondence.

Optionally, any item in the access-control configuration information is configured at any one of: cell granularity, PLMN granularity, SNPN granularity, CAG granularity, or AC granularity.

Optionally, if any item in the access-control configuration information is configured at the AC granularity, the access-control configuration information further includes an AC ID.

Optionally, the AC ID and the access-probability-control configuration information are in one-to-one correspondence or multiple-to-one correspondence.

Optionally, the terminal type is classified according to at least one of a maximum transmission power level supported by the terminal, an application scenario supported by the terminal, a bandwidth size supported by the terminal, whether the terminal is served in an operator network that the terminal subscribes to, or the number of transmit antennas and/or the number of receive antennas supported by the terminal.

Optionally, the geographic region information includes coordinate information of multiple reference points, or latitude-longitude range information.

Optionally, the information related to the serving cell of the terminal includes at least one of a CGI, a TAC ID, a RANAC ID, frequency-point information, a PCI, beam information, bandwidth configuration information, RAT information, or core-network type information.

Optionally, the access-control configuration information further includes an ID of the target network.

Optionally, the target network is any one of: a PLMN network, an SNPN network, or a CAG network.

Optionally, the access-control configuration information is carried in a system broadcast message or dedicated signaling.

Optionally, if the access-control configuration information is carried in the dedicated signaling, the access-control configuration information further includes timer information. The access-control configuration information in the dedicated signaling is valid before expiry of the timer; otherwise, the access-control configuration information in the dedicated signaling is invalid.

Optionally, the communicating unit 410 is further configured to send the system broadcast message if the access-control configuration information is carried in the dedicated signaling and the access-control configuration information in the dedicated signaling is invalid.

Optionally, in some implementations, the communicating unit above may be a communication interface or a transceiver, or may be an input-output interface of a communication chip or SOC. The processing unit above may be one or more processors.

It should be understood that, the network device 400 according to implementations of the disclosure may correspond to the network device in the method implementations of the disclosure, and the above and other operations and/or functions of various units of the network device 400 are respectively intended for implementing corresponding operations of the network device in implementation 1 to implementation 4, which will not be repeated herein for the sake of simplicity.

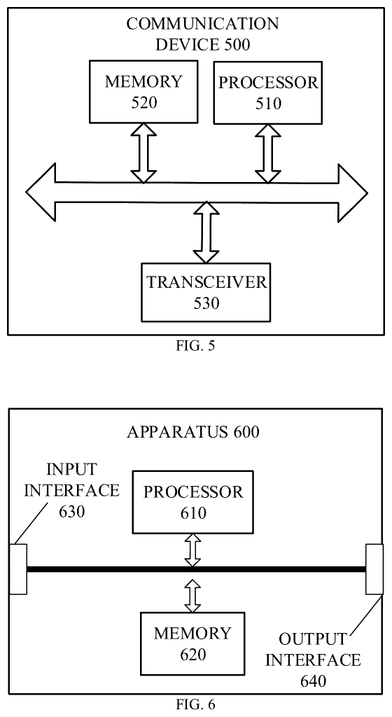

FIG. 5 is a schematic structural diagram of a communication device 500 provided in implementations of the disclosure. The communication device 500 illustrated in FIG. 5 includes a processor 510. The processor 510 can invoke and execute computer programs stored in a memory, to perform the method in implementations of the disclosure.

Optionally, as illustrated in FIG. 5, the communication device 500 may further include the memory 520. The processor 510 can invoke and execute the computer programs stored in the memory 520, to perform the method in implementations of the disclosure.

The memory 520 may be a separate device independent of the processor 510, or may be integrated into the processor 510.

Optionally, as illustrated in FIG. 5, the communication device 500 can further include a transceiver 530. The processor 510 can control the transceiver 530 to communicate with other devices, specifically, to transmit information or data to other devices or to receive information or data transmitted by other devices.

The transceiver 530 may include a transmitter and a receiver. The transceiver 530 may further include an antenna, where one or more antennas can be provided.

Optionally, the communication device 500 may be operable as the network device in implementations of the disclosure, and the communication device 500 can implement the operations performed by the network device in various methods in implementations of the disclosure, which will not be repeated herein for the sake of simplicity.

Optionally, the communication device 500 may be operable as the target terminal in implementations of the disclosure, and the communication device 500 can implement the operations performed by the target terminal in various methods in implementations of the disclosure, which will not be repeated herein for the sake of simplicity.

FIG. 6 is a schematic structural diagram of an apparatus according to implementations of the disclosure. The apparatus 600 illustrated in FIG. 6 includes a processor 610. The processor 610 can invoke and execute computer programs stored in a memory to perform the method in implementations of the disclosure.

Optionally, as illustrated in FIG. 6, the apparatus 600 further includes the memory 620. The processor 610 can invoke and execute the computer programs stored in the memory 620 to perform the method in implementations of the disclosure.

The memory 620 may be a separate device independent of the processor 610, or may be integrated into the processor 610.

Optionally, the apparatus 600 may further include an input interface 630. The processor 610 can control the input interface 630 to communicate with other devices or chips, specifically, to obtain information or data transmitted by other devices or chips.

Optionally, the apparatus 600 may further include an output interface 640. The processor 610 can control the output interface 640 to communicate with other devices or chips, specifically, to output information or data to other devices or chips.

Optionally, the apparatus is applicable to the network device in implementations of the disclosure. The apparatus can implement the operations performed by the network device in various methods in implementations of the disclosure, which will not be repeated herein for the sake of simplicity.

Optionally, the apparatus is applicable to the terminal device in implementations of the disclosure. The apparatus can implement the operations performed by the terminal device in various methods in implementations in the disclosure, which will not be repeated herein for the sake of simplicity.

It should be understood that, the apparatus referred to in implementations of the disclosure may also be a chip, such as an SOC.

Implementation 9

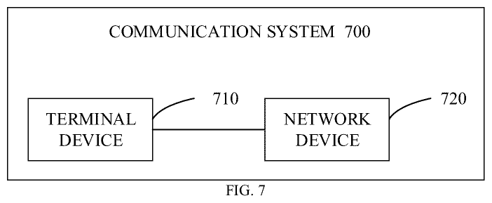

FIG. 7 is a schematic block diagram of a communication system 700 provided in implementations of the disclosure. As illustrated in FIG. 7, the communication system 700 includes a terminal device 710 and a network device 720.

The terminal device 710 can implement functions of the terminal device in the foregoing methods, and the network device 720 can implement functions of the network device or the base station in the foregoing methods, which will not be repeated herein for the sake of simplicity.

It should be understood that, the processor in implementations of the disclosure may be an integrated circuit chip with signal processing capabilities. During implementation, each step of the foregoing method implementations may be completed by an integrated logic circuit of hardware in the processor or an instruction in the form of software. The processor may be a general-purpose processor, a digital signal processor (DSP), an application specific integrated circuit (ASIC), a field programmable gate array (FPGA), or other programmable logic devices, discrete gates or transistor logic devices, discrete hardware components. The methods, steps, and logic blocks disclosed in implementations of the disclosure can be implemented or executed. The general purpose processor may be a microprocessor, or the processor may be any conventional processor or the like. The steps of the method disclosed in implementations of the disclosure may be directly implemented by a hardware decoding processor, or may be performed by hardware and software modules in the decoding processor. The software module can be located in a storage medium such as a random access memory (RAM), a flash memory, a read only memory (ROM), a programmable ROM (PROM), or an electrically erasable programmable memory, registers, and the like. The storage medium is located in the memory. The processor reads the information in the memory, and completes the steps of the method described above with the hardware thereof.

It can be understood that, the memory in implementations of the disclosure may be a volatile memory or a non-volatile memory, or may include both the volatile memory and the non-volatile memory. The non-volatile memory may be a ROM, a PROM, an erasable PROM (EPROM), an electrically EPROM (EEPROM), or flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that, the memory of the systems and methods described in the disclosure is intended to include, but is not limited to, these and any other suitable types of memory.

It should be understood that, the memory above is intended for illustration rather than limitation. For example, the memory in implementations of the disclosure may also be an SRAM, a DRAM, an SDRAM, a DDR SDRAM, an ESDRAM, an SLDRAM, a DR RAM, etc. In other words, the memory in implementations of the disclosure is intended to include, but is not limited to, these and any other suitable types of memory.

Implementations of the disclosure further provide a computer-readable storage medium. The computer-readable storage medium is configured to store computer programs.

Optionally, the computer-readable storage medium is applicable to the network device or the base station of implementations of the disclosure. The computer programs are operable with a computer to implement the operations performed by the network device or the base station in various methods in implementations of the disclosure, which will not be repeated herein for the sake of simplicity.

Optionally, the computer-readable storage medium is applicable to the mobile terminal/the terminal device of implementations of the disclosure. The computer programs are operable with a computer to implement the operations performed by the mobile terminal/the terminal device in various methods in implementations of the disclosure, which will not be repeated herein for the sake of simplicity.

Implementations of the disclosure further provide a computer program product. The computer program product includes computer program instructions.

Optionally, the computer program product is applicable to the network device or the base station of implementations of the disclosure. The computer program instructions are operable with a computer to implement the operations performed by the network device or the base station in various methods in implementations of the disclosure, which will not be repeated herein for the sake of simplicity.

Optionally, the computer program product is applicable to the mobile terminal/the terminal device of implementations of the disclosure. The computer program instructions are operable with a computer to implement the operations performed by the mobile terminal/the terminal device in various methods in implementations of the disclosure, which will not be repeated herein for the sake of simplicity.

Implementations of the disclosure further provide a computer program.

Optionally, the computer program is applicable to the network device or the base station of implementations of the disclosure. The computer program, when executed by a computer, is operable with the computer to implement the operations performed by the network device or the base station in various methods in implementations of the disclosure, which will not be repeated herein for the sake of simplicity.

Optionally, the computer program is applicable to the mobile terminal/the terminal device of implementations of the disclosure. The computer program, when executed by a computer, is operable with the computer to implement the operations performed by the mobile terminal/the terminal device in various methods in implementations of the disclosure, which will not be repeated herein for the sake of simplicity.

Those of ordinary skill in the art will appreciate that units and algorithmic operations of various examples described in connection with implementations of the disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure.

It will be evident to those skilled in the art that, for the sake of convenience and simplicity, in terms of the specific working processes of the foregoing systems, apparatuses, and units, reference can be made to the corresponding processes in the foregoing method implementations, which will not be repeated herein.

It will be appreciated that the systems, apparatuses, and methods disclosed in implementations of the disclosure may also be implemented in various other manners. For example, the above apparatus implementations are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of the disclosure.

In addition, various functional units described in various implementations of the disclosure may be integrated into one processing unit or may be present as a number of physically separated units, and two or more units may be integrated into one.

If the functions are implemented as software functional units and sold or used as standalone products, they may be stored in a computer-readable storage medium. Based on such an understanding, the essential technical solution, or the portion that contributes to the prior art, or part of the technical solution of the disclosure may be embodied as software products. The computer software products can be stored in a storage medium and may include multiple instructions that, when executed, can cause a computing device, e.g., a personal computer, a server, a network device, etc., to execute some or all operations of the methods described in various implementations of the disclosure. The above storage medium may include various kinds of media that can store program codes, such as a universal serial bus (USB) flash disk, a mobile hard drive, a ROM, a RAM, a magnetic disk, or an optical disk.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A wireless communication method, comprising:
obtaining access-control configuration information; and
performing cell access control according to the access-control configuration information;
wherein the access-control configuration information indicates information related to a terminal barred from accessing a target network or allowed to access the target network.

2. The method of claim 1, wherein the access-control configuration information comprises at least one of:
information of a terminal type barred from accessing the target network or allowed to access the target network;
geographic region information of the terminal barred from accessing the target network or allowed to access the target network; and
information related to a serving cell of the terminal barred from accessing the target network or allowed to access the target network.

3. The method of claim 2, wherein when the access-control configuration information indicates information related to a terminal allowed to access the target network, the access-control configuration information further comprises:
access-probability-control configuration information for the terminal to access the target network.

4. The method of claim 3, wherein the access-probability-control configuration information comprises a probability configuration parameter for the terminal to access the target network.

5. The method of claim 4, wherein the access-probability-control configuration information further comprises:
a back-off time parameter, wherein the back-off time parameter is used for determining a minimum waiting duration required before re-initiating a service after the terminal fails to access the target network.

6. The method of claim 3, wherein at least one of:
the information of the terminal type and the access-probability-control configuration information are in one-to-one correspondence or multiple-to-one correspondence;
the geographic region information and the access-probability-control configuration information are in one-to-one correspondence or multiple-to-one correspondence; and
the information related to the serving cell of the terminal and the access-probability-control configuration information are in one-to-one correspondence or multiple-to-one correspondence.

7. The method of claim 3, wherein any item in the access-control configuration information is configured at any one of: cell granularity, public land mobile network (PLMN) granularity, stand-alone non-public network (SNPN) granularity, closed access group (CAG) granularity, or access category (AC) granularity.

8. The method of claim 7, wherein when any item in the access-control configuration information is configured at the AC granularity, the access-control configuration information further comprises an AC identity (ID).

9. The method of claim 8, wherein the AC ID and the access-probability-control configuration information are in one-to-one correspondence or multiple-to-one correspondence.

10. The method of claim 2, wherein the terminal type is classified according to at least one of:
a maximum transmission power level supported by the terminal;
an application scenario supported by the terminal;
a bandwidth size supported by the terminal;
whether the terminal is served in an operator network that the terminal subscribes to; and
a number of transmit antennas and/or a number of receive antennas supported by the terminal.

11. The method of claim 2, wherein the geographic region information comprises: coordinate information of a plurality of reference points, or latitude-longitude range information.

12. The method of claim 2, wherein the information related to the serving cell of the terminal comprises at least one of:
a cell global identity (CGI);
a tracking area code (TAC) ID;
a radio access network area code (RANAC) ID;
frequency-point information;
a physical cell identity (PCI);
beam information;
bandwidth configuration information;
radio access technology (RAT) information; and
core-network type information.

13. The method of claim 2, wherein the access-control configuration information further comprises an ID of the target network, wherein the target network is any one of: a PLMN network, an SNPN network, or a CAG network.

14. The method of claim 1, wherein the access-control configuration information is carried in a system broadcast message or dedicated signaling.

15. The method of claim 14, wherein when the access-control configuration information is carried in the dedicated signaling, the access-control configuration information further comprises timer information;
wherein the access-control configuration information in the dedicated signaling is valid before expiry of the timer; otherwise, the access-control configuration information in the dedicated signaling is invalid.

16. The method of claim 15, wherein when the access-control configuration information is carried in the dedicated signaling and the access-control configuration information in the dedicated signaling is invalid, the method further comprises:
receiving the system broadcast message; and
performing cell access control according to the access-control configuration information carried in the system broadcast message.

17. The method of claim 1, wherein obtaining the access-control configuration information comprises:
obtaining the access-control configuration information via an access stratum (AS); and
wherein the method further comprises:
transferring the access-control configuration information to a non-access stratum (NAS) via the AS.

18. A wireless communication method, comprising:
sending access-control configuration information;
wherein the access-control configuration information indicates information related to a terminal barred from accessing a target network or allowed to access the target network.

19. A terminal device, comprising:
a transceiver;
a memory configured to store computer programs; and
a processor configured to execute the computer programs stored in the memory, to:
cause the transceiver to obtain access-control configuration information; and
perform cell access control according to the access-control configuration information;
wherein the access-control configuration information indicates information related to a terminal barred from accessing a target network or allowed to access the target network.

20. A network device, comprising:
a transceiver;
a memory configured to store computer programs; and
a processor configured to execute the computer programs stored in the memory, to perform the method of claim 18.
